(19) United States
(12) Patent Application Publication
(10) Pub. No.: US 2017/0087926 A1
(43) Pub. Date: Mar. 30, 2017

(54) Paint Roller Cleaning Assembly

(71) Applicant: Terrance Campbell, Miami Gardens, FL (US)

(72) Inventor: Terrance Campbell, Miami Gardens, FL (US)

(21) Appl. No.: 14/866,861

(22) Filed: Sep. 26, 2015

(51) Int. Cl. B44D 3/00; B08B 3/02; B08B 3/10

(52) U.S. Cl. CPC B44D 3/006; B08B 3/10; B08B 3/02

(57) ABSTRACT

A paint roller cleaning assembly includes a pan that may have a paint roller positioned therein. A lid is hingedly coupled to the pan and the lid is positionable between an open position and a closed position. A rotating unit is positioned within the pan. The rotating unit may have the paint roller removably coupled thereto thereby facilitating the rotating unit to spin the paint roller. The rotating unit may impart a centrifugal force on the paint roller such that a paint on the paint roller is urged away from the paint roller. A washing unit is positioned within the pan. The washing unit may urge a fluid onto the paint roller when the paint roller is coupled to the rotating unit thereby facilitating the paint roller to be washed.

### BACKGROUND OF THE DISCLOSURE

### Field of the Disclosure

The disclosure relates to cleaning devices and more particularly pertains to a new cleaning device for cleaning a paint roller.

### SUMMARY OF THE DISCLOSURE

An embodiment of the disclosure meets the needs presented above by generally comprising a pan that may have a paint roller positioned therein. A lid is hingedly coupled to the pan and the lid is positionable between an open position and a closed position. A rotating unit is positioned within the pan. The rotating unit may have the paint roller removably coupled thereto thereby facilitating the rotating unit to spin the paint roller. The rotating unit may impart a centrifugal force on the paint roller such that a paint on the paint roller is urged away from the paint roller. A washing unit is positioned within the pan. The washing unit may urge a fluid onto the paint roller when the paint roller is coupled to the rotating unit thereby facilitating the paint roller to be washed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a paint roller cleaning assembly according to an embodiment of the disclosure.

FIG. 2 is a top perspective view an embodiment of the disclosure.

FIG. 3 is a cross sectional view taken along line 3-6 of FIG. 1 of an embodiment of the disclosure.

FIG. 4 is a cross sectional view taken along line 4-4 of FIG. 3 of an embodiment of the disclosure.

FIG. 5 is a bottom view of an embodiment of the disclosure.

### DESCRIPTION OF THE PREFERRED EMBODIMENT

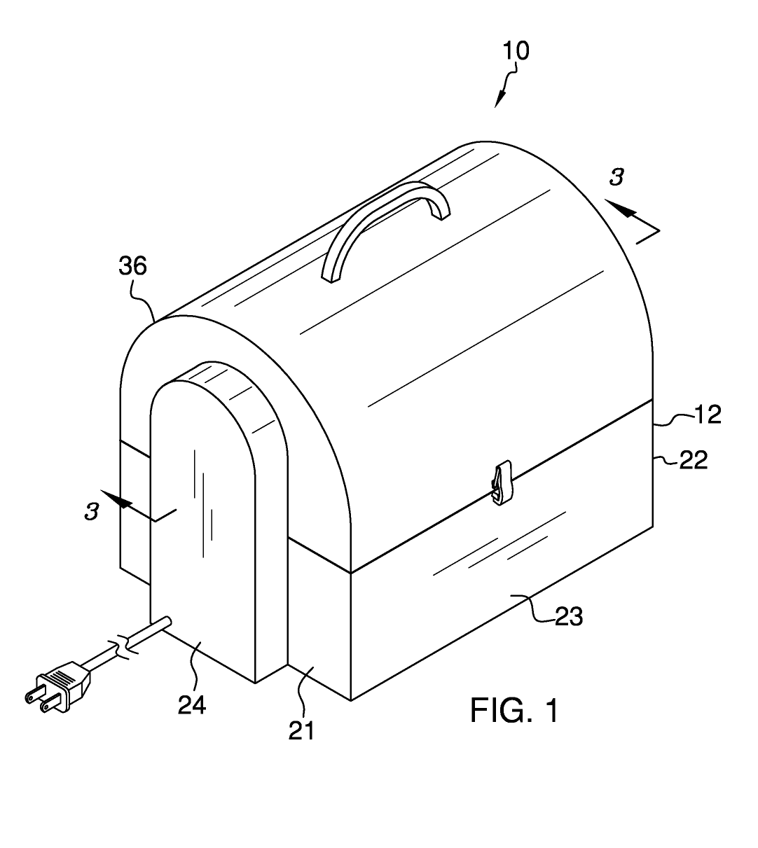

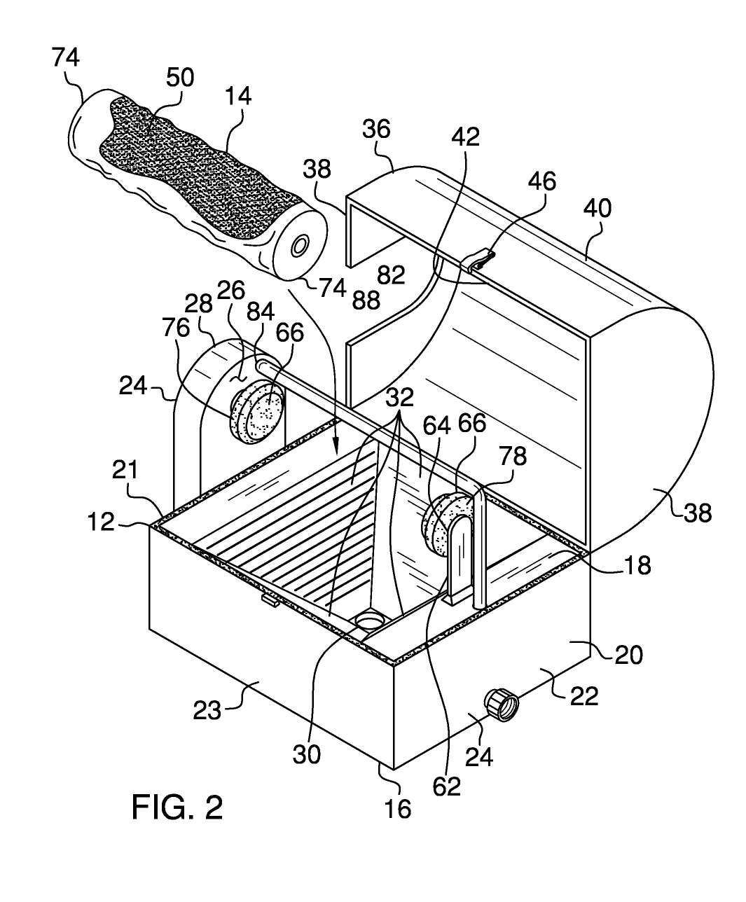

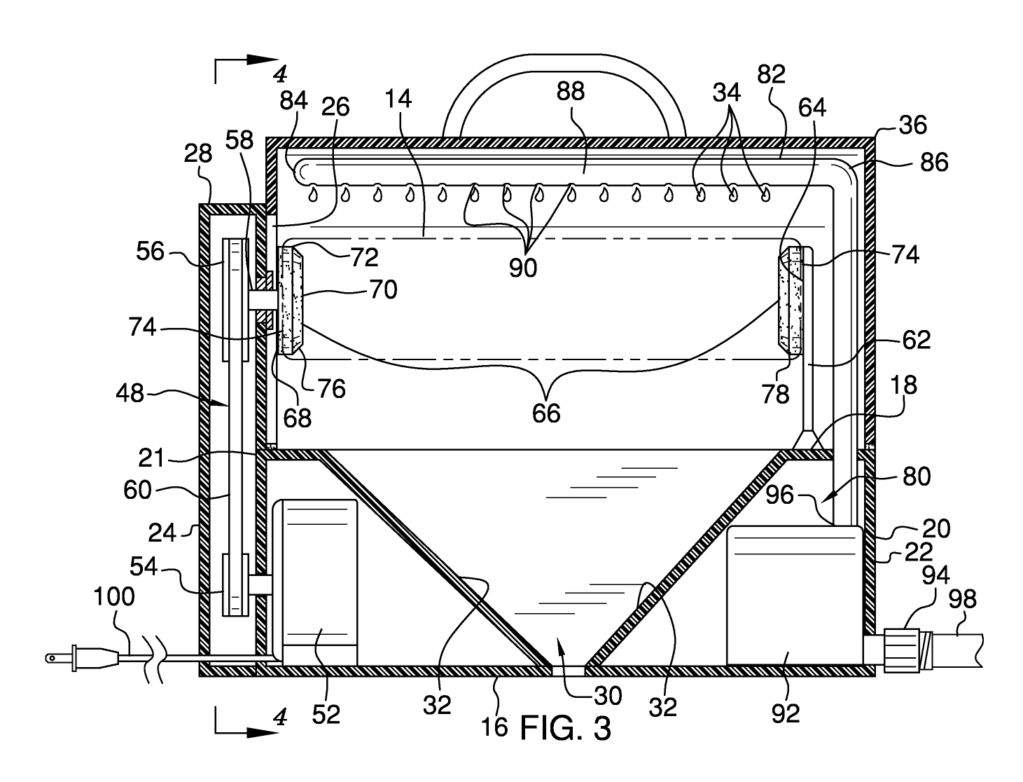

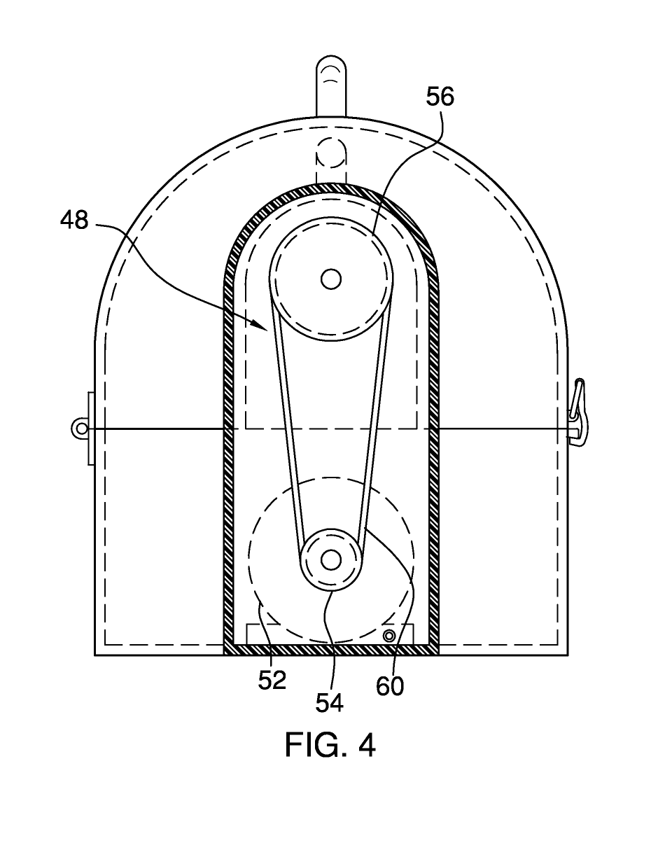

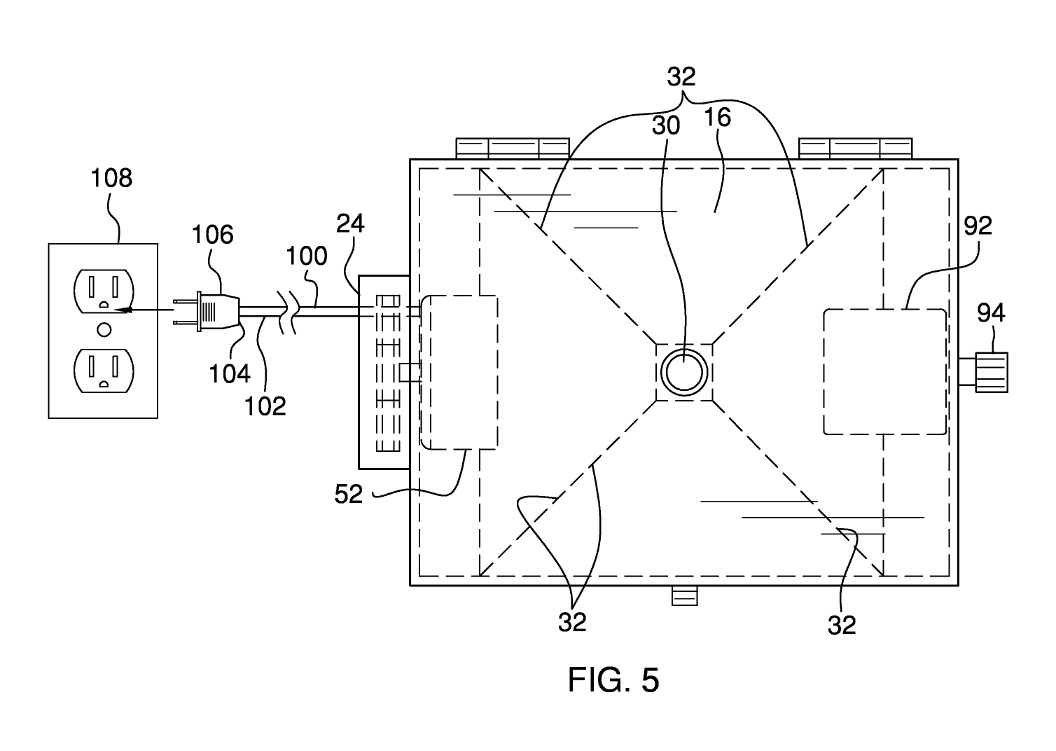

With reference now to the drawings, and in particular to FIGS. 1 through 5 thereof, a new cleaning device embodying the principles and concepts of an embodiment of the disclosure and generally designated by the reference numeral 10 will be described.

As best illustrated in FIGS. 1 through 5, the paint roller cleaning assembly 10 generally comprises a pan 12 that may have a paint roller 14 positioned therein. The pan 12 has a bottom wall 16, a top wall 18 and a peripheral wall 20 extending between the top wall 18 and the bottom wall 16. The peripheral wall 20 has a first lateral side 21, a second lateral side 22 and a front side 23. The pan 12 has a housing portion 24 that is coupled to the first lateral side 21 and the housing portion 24 extends upwardly beyond the top wall 18. The housing portion 24 has an inwardly facing surface 26 and a distal end 28 with respect to the top wall 18.

The bottom wall 16 has an opening 30 extending therethrough. The opening 30 is centrally positioned on the bottom wall 16. The top wall 18 has a plurality of intersecting sections 32. Each of the intersecting sections 32 angles downwardly toward the opening 30. Thus, each of the intersecting sections 32 may direct a fluid 34 into the opening 30.

A lid 36 is hingedly coupled to the pan 12 such that the lid 36 is positionable between an open position and a closed position. The lid 36 has a pair of lateral walls 38 and a center wall 40 extending between each of the lateral walls 38. The center wall 40 is curved such that the lid 36 has a semi-cylindrical shape. The lid 36 has a lower edge 42 and the lower edge 42 corresponding to the first lateral side 21 has a slot 44 extending upwardly therein. The housing portion 24 of the pan 12 is positioned within the slot 44 when the lid 36 is positioned in the closed position.

A latch 46 is provided and the latch 46 is coupled to the center wall 40 of the lid 36. The latch 46 is positioned adjacent to the lower edge 42. The latch 46 may be manipulated to engage the front side 23 of the pan 12 when the lid 36 is positioned in the closed position. Thus, the latch 46 retains the lid 36 in the closed position.

A rotating unit 48 is positioned within the pan 12. The rotating unit 48 may have the paint roller 14 removably coupled thereto thereby facilitating the rotating unit 48 to spin the paint roller 14. The rotating unit 48 may impart a centrifugal force on the paint roller 14 such that a paint 50 on the paint roller 14 is urged away from the paint roller 14. The paint roller 14 may be a paint roller of any conventional design.

The rotating unit 48 comprises a motor 52 that is coupled to the bottom wall 16. The motor 52 is positioned between the bottom wall 16 and one of the intersecting sections 32 of the top wall 18. The motor 52 is positioned adjacent to the first lateral side 21 and the motor 52 may comprise an electrical motor or the like. A first pulley 54 is rotatably coupled to the motor 52 such that the motor 52 rotates the first pulley 54 when the motor 52 is turned on. The first pulley 54 is positioned within the housing portion 24.

A second pulley 56 is rotatably coupled to the housing portion 24 and the second pulley 56 is positioned within the housing portion 24. The second pulley 56 is spaced from the first pulley 54. The second pulley 56 has a shaft 58 extending through the inwardly facing surface 26 of the housing portion 24. A belt 60 extends around the first pulley 54 and the second pulley 56 such that belt 60 rotates the second pulley 56 when the motor 52 rotates the first pulley 54.

A support 62 is coupled to and extends upwardly from the top wall 18 of the pan 12. The support 62 is positioned adjacent to the second lateral side 22 and the support 62 is aligned with the housing portion 24. The support 62 has an inwardly facing surface 64. The inwardly facing surface 64 of the support 62 faces the inwardly facing surface 26 of the housing portion 24. A pair of pads 66 is provided and each of the pads 66 has a first surface 68, a second surface 70 and an exterior edge 72 extending between the first surface 68 and the second surface 70. The second surface 70 tapers inwardly from the exterior edge 72. Thus, the second surface may frictionally engage an associated one of a pair of ends 74 of the paint roller 14.

The pair of pads 66 includes a first pad 76 and a second pad 78. The first surface 68 of the first pad 76 is coupled to the shaft 58 such that the second pulley 56 rotates the first pad 76 when the motor 52 rotates the first pulley 54. The first pad 76 is positioned adjacent to the distal end 28 of the housing portion 24. The first surface 68 of the second pad 78 is rotatably coupled to the inwardly facing surface 64 of the support 62. The first pad 76 and the second pad 78 may have the paint roller 14 extending between the first pad 76 and the second pad 78 when the paint roller 14 is coupled to the rotating unit 48.

A washing unit 80 is positioned within the pan 12. The washing unit 80 may urge the fluid 34 onto the paint roller 14 when the paint roller 14 is coupled to the rotating unit 48 thereby facilitating the paint roller 14 to be washed. The washing unit 80 comprises a spray bar 82 that is coupled to and extends upwardly from the top wall 18. The spray bar 82 is positioned adjacent to the first lateral side 21 and the spray bar 82 has a distal end 84 with respect to the top wall 18.

The spray bar 82 has a bend 86 positioned between the top wall 18 and the distal end 84 of the spray bar 82 to define a lateral portion 88 of the spray bar 82. The lateral portion 88 extends toward the second lateral side 22. The distal end 84 of the spray bar 82 is spaced from the housing portion 24. The lateral portion 88 is coextensive with the paint roller 14 when the paint roller 14 is coupled to the rotating unit 48. The lateral portion 88 has a plurality of openings 90 extending therethrough. The openings 90 are spaced apart from each other and are distributed along the lateral portion 88. Thus, the openings 90 are directed toward the paint roller 14 when the paint roller 14 is coupled to the rotating unit 48.

A pump 92 is coupled to the bottom wall 16 and the pump 92 is positioned between the bottom wall 16 and one of the intersecting sections 32 of the top wall 18. The pump 92 has an inlet 94 and an outlet 96. The inlet 94 extends outwardly from the second lateral side 22 and the inlet 94 may be fluidly coupled to a fluid source 98. The fluid source 98 may be a water hose or the like and the fluid 34 may comprise water. The outlet 96 is fluidly coupled to the spray bar 82. Thus, the pump 92 may urge the fluid 34 outwardly through the openings 88 thereby facilitating the fluid 34 to wash the paint roller 14.

A power supply 100 is coupled to the pan 12 and the power supply 100 is electrically coupled to the pump 92 and the motor 52. The power supply 100 comprises a cord 102 extending outwardly from the second lateral side 22. The cord 102 has a distal end 104 with respect to the second lateral side 22. A plug 106 is electrically coupled to the distal end 104 of the cord 102. The plug 106 may be electrically coupled to a power source 108 and the power source 108 may comprise an electrical outlet or the like.

In use, the fluid source 98 is fluidly coupled to the inlet 94 of the pump 92. The paint roller 14 is positioned between the first pad 76 and the second pad 78 when the paint roller 14 is to be cleaned. The lid 36 is positioned in the closed position and the cord 102 is electrically coupled to the power source 108. The motor 52 rotates the paint roller 14 and the pump 92 urges the fluid 34 onto the paint roller 14. Thus, the paint 50 is cleaned from the paint roller 14 and the fluid 34 drains outwardly through the opening 30 in the bottom wall 18. The cord 102 is electrically un-coupled from the power source 108 after a selected amount of time and the paint roller 14 is removed from the pan 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A paint roller cleaning assembly comprising:
a pan being configured to have a paint roller positioned therein;
a lid being hingedly coupled to said pan such that said lid is positionable between an open position and a closed position;
a rotating unit being positioned within said pan, said rotating unit being configured to have the paint roller removably coupled thereto thereby facilitating said rotating unit to spin the paint roller, said rotating unit being configured to impart a centrifugal force on the paint roller such that a paint on the paint roller is urged away from the paint roller; and
a washing unit being positioned within said pan, said washing unit being configured to urge a fluid onto the paint roller when the paint roller is coupled to said rotating unit thereby facilitating the paint roller to be washed.

2. The assembly according to claim 1, wherein said pan has a bottom wall, a top wall and a peripheral wall extending between said top wall and said bottom wall, said peripheral wall having a first lateral side and a second lateral side, said pan having a housing portion being coupled to said first lateral side, said housing portion extending upwardly beyond said top wall, said housing portion having an inwardly facing surface and a distal end with respect to said top wall.

3. The assembly according to claim 2, wherein said bottom wall has an opening extending therethrough, said opening being centrally positioned on said bottom wall, said top wall having a plurality of intersecting sections, each of said intersecting sections angling downwardly toward said opening wherein each of said intersecting sections is configured to direct a fluid into said opening.

4. The assembly according to claim 1, wherein:
said pan has a housing portion, and;
said lid has a pair of lateral walls and a center wall extending between each of said lateral walls, said center wall being curved such that said lid has a semi-cylindrical shape, said lid having a lower edge, said lower edge corresponding to said first lateral side having a slot extending upwardly therein, said housing portion of said pan being positioned within said slot when said lid is positioned in said closed position.

5. The assembly according to claim 3, wherein said rotating unit comprises a motor being coupled to said bottom wall, said motor being positioned between said bottom wall and one of said intersecting sections of said top wall, said motor being positioned adjacent to said first lateral side.

6. The assembly according to claim 5, further comprising a first pulley being rotatably coupled to said motor such that said motor rotates said first pulley when said motor is turned on, said first pulley being positioned within said housing portion.

7. The assembly according to claim 6, further comprising a second pulley being rotatably coupled to said housing portion, said second pulley being positioned within said housing portion, said second pulley being spaced from said first pulley, said second pulley having a shaft extending through said inwardly facing surface of said housing portion.

8. The assembly according to claim 7, further comprising a belt extending around said first pulley and said second pulley such that belt rotates said second pulley when said motor rotates said first pulley.

9. The assembly according to claim 3, further comprising a support being coupled to and extending upwardly from said top wall of said pan, said support being positioned adjacent to said second lateral side, said support being aligned with said housing portion, said support having an inwardly facing surface, said inwardly facing surface of said support facing said inwardly facing surface of said housing portion.

10. The assembly according to claim 1, further comprising a pair of pads, each of said pads having a first surface, a second surface and an exterior edge extending between said first surface and said second surface, said second surface tapering inwardly from said exterior edge wherein said second surface of each of said pads is configured to engage an associated one of a pair of ends of the paint roller.

11. The assembly according to claim 10, wherein:
said rotating unit includes a second pulley, a shaft, a first pulley and a motor;
said pan having a housing portion, said housing portion having a distal end; and
said pair of pads includes a first pad and a second pad, said first surface of said first pad being coupled to said shaft such that said second pulley rotates said first pad when said motor rotates said first pulley, said first pad being positioned adjacent to said distal end of said housing portion.

12. The assembly according to claim 10, wherein:
said rotating unit includes a support, said support having an inwardly facing surface; and
said first surface of said second pad is rotatably coupled to said inwardly facing surface of said support such that first pad and said second pad are configured to have the paint roller extending between said first pad and said second pad when the paint roller is coupled to said rotating unit.

13. The assembly according to claim 3, wherein said washing unit comprises a spray bar being coupled to and extending upwardly from said top wall, said spray bar being positioned adjacent to said first lateral side, said spray bar having a distal end with respect to said top wall, said spray bar having a bend being positioned between said top wall and said distal end to define a lateral portion of said spray bar.

14. The assembly according to claim 13, wherein said lateral portion extends toward said second lateral side having said distal end being spaced from said housing portion wherein said lateral portion is configured to be coextensive with the paint roller when the paint roller is coupled to said rotating unit.

15. The assembly according to claim 13, wherein said lateral portion has a plurality of openings extending therethrough, said openings being spaced apart from each other and being distributed along said lateral portion wherein said openings are configured to be directed toward the paint roller.

16. The assembly according to claim 15, further comprising a pump being coupled to said bottom wall, said pump being positioned between said bottom wall and one of said intersecting sections of said top wall, said pump having an inlet and an outlet, said inlet extending outwardly from said second lateral side wherein said inlet is configured to be fluidly coupled to a fluid source, said outlet being fluidly coupled to said spray bar wherein said pump is configured to urge the fluid outwardly through said openings thereby facilitating the fluid to wash the paint roller.

17. The assembly according to claim 3, further comprising a power supply being coupled to said pan, said power supply being electrically coupled to a pump and a motor, said power supply comprising a cord extending outwardly from said second lateral side, said cord having a distal end with respect to said second lateral side, said distal end having a plug being electrically coupled thereto, said plug being configured to be electrically coupled to a power source.

18. A paint roller cleaning assembly comprising:
a pan being configured to have a paint roller positioned therein, said pan having a bottom wall, a top wall and a peripheral wall extending between said top wall and said bottom wall, said peripheral wall having a first lateral side and a second lateral side, said pan having a housing portion being coupled to said first lateral side, said housing portion extending upwardly beyond said top wall, said housing portion having an inwardly facing surface and a distal end with respect to said top wall, said bottom wall having an opening extending therethrough, said opening being centrally positioned on said bottom wall, said top wall having a plurality of intersecting sections, each of said intersecting sections angling downwardly toward said opening wherein each of said intersecting sections is configured to direct a fluid into said opening;
a lid being hingedly coupled to said pan such that said lid is positionable between an open position and a closed position, said lid having a pair of lateral walls and a center wall extending between each of said lateral walls, said center wall being curved such that said lid has a semi-cylindrical shape, said lid having a lower edge, said lower edge corresponding to said first lateral side having a slot extending upwardly therein, said housing portion of said pan being positioned within said slot when said lid is positioned in said closed position;
a rotating unit being positioned within said pan, said rotating unit being configured to have the paint roller removably coupled thereto thereby facilitating said rotating unit to spin the paint roller, said rotating unit being configured to impart a centrifugal force on the paint roller such that a paint on the paint roller is urged away from the paint roller, said rotating unit comprising:
a motor being coupled to said bottom wall, said motor being positioned between said bottom wall and one of said intersecting sections of said top wall, said motor being positioned adjacent to said first lateral side,
a first pulley being rotatably coupled to said motor such that said motor rotates said first pulley when said motor is turned on, said first pulley being positioned within said housing portion,
a second pulley being rotatably coupled to said housing portion, said second pulley being positioned within said housing portion, said second pulley being spaced from said first pulley, said second pulley having a shaft extending through said inwardly facing surface of said housing portion,
a belt extending around said first pulley and said second pulley such that belt rotates said second pulley when said motor rotates said first pulley,
a support being coupled to and extending upwardly from said top wall of said pan, said support being positioned adjacent to said second lateral side, said support being aligned with said housing portion, said support having an inwardly facing surface, said inwardly facing surface of said support facing said inwardly facing surface of said housing portion, and
a pair of pads, each of said pads having a first surface, a second surface and an exterior edge extending between said first surface and said second surface, said second surface tapering inwardly from said exterior edge wherein said second surface of each of said pads is configured to engage an associated one of a pair of ends of the paint roller, said pair of pads including a first pad and a second pad, said first surface of said first pad being coupled to said shaft such that said second pulley rotates said first pad when said motor rotates said first pulley, said first pad being positioned adjacent to said distal end of said housing portion, said first surface of said second pad being rotatably coupled to said inwardly facing surface of said support such that first pad and said second pad are configured to have the paint roller extending between said first pad and said second pad when the paint roller is coupled to said rotating unit;
a washing unit being positioned within said pan, said washing unit being configured to urge a fluid onto the paint roller when the paint roller is coupled to said rotating unit thereby facilitating the paint roller to be washed, said washing unit comprising:
a spray bar being coupled to and extending upwardly from said top wall, said spray bar being positioned adjacent to said first lateral side, said spray bar having a distal end with respect to said top wall, said spray bar having a bend being positioned between said top wall and said distal end to define a lateral portion of said spray bar, said lateral portion extending toward said second lateral side having said distal end being spaced from said housing portion wherein said lateral portion is configured to be coextensive with the paint roller when the paint roller is coupled to said rotating unit, said lateral portion having a plurality of openings extending therethrough, said openings being spaced apart from each other and being distributed along said lateral portion wherein said openings are configured to be directed toward the paint roller,
a pump being coupled to said bottom wall, said pump being positioned between said bottom wall and one of said intersecting sections of said top wall, said pump having an inlet and an outlet, said inlet extending outwardly from said second lateral side wherein said inlet is configured to be fluidly coupled to a fluid source, said outlet being fluidly coupled to said spray bar wherein said pump is configured to urge the fluid outwardly through said openings thereby facilitating the fluid to wash the paint roller, and
a power supply being coupled to said pan, said power supply being electrically coupled to said pump and said motor, said power supply comprising a cord extending outwardly from said second lateral side, said cord having a distal end with respect to said second lateral side, said distal end having a plug being electrically coupled thereto, said plug being configured to be electrically coupled to a power source.
